(19) United States
(12) Patent Application Publication
(10) Pub. No.: US 2010/0136265 A1
(43) Pub. Date: Jun. 3, 2010

(54) ANTISTATIC OPTICALLY CLEAR PRESSURE SENSITIVE ADHESIVE

(76) Inventors: Albert I. Everaerts, Oakdale, MN (US); Jianhui Xia, Woodbury, MN (US); Wanshik Yoon, Seoul (KR); Dong-Wei Zhu, Shoreview, MN (US); William M. Lamanna, Stillwater, MN (US); Thomas P. Klun, Lakeland, MN (US)

Correspondence Address: 3M INNOVATIVE PROPERTIES COMPANY, PO BOX 33427, ST. PAUL, MN, 55133-3427, US

(21) Appl. No.: 12/595,280

(22) PCT Filed: Apr. 11, 2008
(86) PCT No.: PCT/US08/60075

§ 371 Date: Oct. 9, 2009

Related U.S. Application Data
(60) Provisional application No. 60/911,800, filed on Apr. 13, 2007.

(51) Int. Cl. C09K 19/02; C09J 7/02; B32B 37/14; B05D 5/10; B32B 37/12; C09J 133/02

(52) U.S. Cl. 428/1.31; 428/355 AC; 428/354; 427/208.4; 156/289; 523/168

(57) ABSTRACT

Provided is an optically clear display-grade adhesive comprising (a) a crosslinked acrylic pressure sensitive adhesive, (b) an organic-soluble and dissociable salt, and optionally (c) a non-hydrophilic plasticizer, wherein the adhesive is electrostatically dissipative transmissive to visible light with low haze. Also provided are with methods of making and using the same.

### CROSS REFERENCE TO RELATED APPLICATION

This application claims the benefit of U.S. Provisional Patent Application No. 60/911,800, filed Apr. 13, 2007, the disclosure of which is incorporated by reference herein in its entirety.

### TECHNICAL FIELD

This relates to antistatic, optically-clear pressure sensitive adhesive (OCA) compositions. The disclosed antistatic OCA's are useful, e.g., in a liquid crystal display assembly to bond a polarizer to a liquid crystal cell.

### BACKGROUND

Optically clear pressure sensitive adhesives (OCA) can be used to adhere a polarizer to a liquid crystal cell in liquid crystal display (LCD) applications. The polarizer may be any type, such as H-polarizers and K-polarizers. The polarizer may be in direct contact or indirect contact with the OCA. The external layer of the liquid crystal cell is typically glass. The basic requirements for the OCA's used in this LCD application include high optical clarity, low haze, and low birefringence.

The OCA typically is supplied on a release liner for the adhesive. Residual static charge of several hundred volts may be left on the adhesive when the release liner is removed from the adhesive surface. Such a large charge may adversely affect the orientation of the liquid crystals when the OCA is applied to the liquid crystal cell or the charge may damage electronic circuitry, so this residual charge must be reduced to a non-damaging level before the OCA is applied to the liquid crystal cell.

Conductive adhesives and antistatic liners have been suggested to reduce or eliminate the residual charge concerns. Known conductive pressure sensitive adhesives are also antistatic because they can readily dissipate localized charges. However, such conductive adhesives use electrically conductive particles, such as carbon fibers, nickel particles, or metal coated glass beads. Such electrically conductive particles are colored or large enough to scatter light, and these conductive adhesives are not optically clear. Antistatic properties can be achieved through a conductive coating on the surface of a pressure sensitive adhesive tape backing or on the surface of the adhesive itself. For example, antistatic pressure sensitive tapes or sheets may be prepared by using a vanadium pentoxide conductive coating between the adhesive and the tape backing.

However, because the adhesive typically is not a good charge carrier, placing the conductive coating between the adhesive and the tape backing does not allow charge on the surface of the adhesive to be discharged quickly and only renders the adhesive somewhat static dissipative. As expected, the thicker the adhesive layer, the slower the charge can be dissipated. Static dissipative properties have also been achieved by using an antistatic release liner with the adhesive. This can dissipate the charge on the release liner, but it stills leaves substantial amount of charge on the adhesive surface.

### SUMMARY

The present inventors have addressed the need to provide an antistatic optically clear pressure sensitive adhesive. Such adhesive is useful, for example, in LCD applications. In some applications, such OCA's also should be insensitive to moisture and be stable in a high temperature and/or high humidity environment.

In some applications, the polarizer-OCA laminate should be reworkable. For example, in LCD assembly applications it may be desirable or necessary to remove the polarizer layer, such as when the initial construction is not completely satisfactory. In this case the adhesion level of the antistatic OCA must allow the polarizer and the LCD to be separated without damaging the LCD. Thus, the initial adhesion level of the antistatic OCA should be sufficient to hold the assembly together, but the adhesion level should not increase over time to such a high level that, if rework is necessary, the LCD may be damaged when the polarizer layer is removed. In addition, the antistatic OCA should have sufficient cohesive strength that no residue remains on the LCD when the adhesive and polarizer are removed. Additionally, the OCA adhesive strength should not exceed the tear strength of the polarizer, so the polarizer and adhesive can be removed together without tearing the polarizer.

Thus, the present disclosure provides an antistatic, optically clear adhesive with good surface conductivity, which may be provided together with good bulk conductivity. With these new antistatic, optically clear adhesives, the static charge on the adhesive surface may be dissipated very quickly and LCD failures due to static discharge during assembly may be substantially eliminated.

Briefly, the present disclosure provides an optically clear display-grade adhesive comprising a crosslinked acrylic pressure sensitive adhesive, an organic-soluble and dissociable salt, and optionally, a non-hydrophilic plasticizer, wherein the adhesive is electrostatically dissipative and is at least about 80%, at least about 85%, or even at least about 90% transmissive to visible light and is below about 15%, below about 10%, below about 8%, or even below about 5% haze.

In another aspect, the present disclosure provides a method of making an optically clear display-grade adhesive comprising providing at least one acrylic monomer and optionally at least one comonomer, blending the monomer(s) with an organic-soluble dissociable salt and a crosslinker to form an adhesive precursor composition, providing the adhesive precursor composition onto a first release liner, and activating the crosslinker to form a crosslinked acrylic pressure sensitive adhesive, wherein the adhesive is electrostatically dissipative, and optionally wherein the adhesive is at least about 80%, at least about 85%, or even at least about 90% transmissive to visible light and has a haze level below about 15%, below about 10%, below about 8%, or even below about 5% haze.

In another aspect, the present disclosure provides a multilayer polarizer comprising a crosslinked acrylic pressure sensitive adhesive which includes a dissociable, organic-soluble salt, and optionally includes a non-hydrophilic plasticizer, wherein the adhesive is electrostatically dissipative, wherein the polarizer further comprises one or more layers selected from an anti-glare layer, a protective layer, a reflective layer, a phase retardation layer, a wide-angle compensation layer, and a brightness enhancing layer.

In another aspect, the present disclosure provides a liquid crystal display comprising a crosslinked acrylic pressure sensitive adhesive which includes a dissociable, organic-soluble salt, and optionally includes a non-hydrophilic plasticizer, wherein the adhesive is electrostatically dissipative, along with a polarizer and a liquid crystal cell, optionally wherein the adhesive is provided on both sides of the liquid crystal cell.

In another aspect, the present disclosure provides a method of making an optically clear display-grade adhesive comprising providing a syrup made by mixing an acrylic polymer with at least one acrylic monomer and optionally at least one comonomer, blending the syrup with a photoinitiator, an organic-soluble dissociable salt, a crosslinker, and optionally a plasticizer to form an adhesive precursor composition, providing the adhesive precursor composition onto a first release liner, and activating the photoinitiator to form a crosslinked acrylic pressure sensitive adhesive, wherein the adhesive is electrostatically dissipative.

In this document “(meth)acrylic group” includes both acrylic and methacrylic groups, “(meth)acrylate polymer” includes both acrylate and methacrylate polymer, “substituted” means substituted by conventional substituents which do not interfere with the desired product, e.g., substituents can be alkyl, alkoxy, aryl, phenyl, halo (F, Cl, Br, I), cyano, nitro, etc., and “electrostatically dissipative” means that the surface resistance of the sample is less than 10¹³ ohms/square.

In this document “non-hydrophilic” refers to a substance that can absorb less than its own weight in moisture from its surroundings.

It is an advantage of one or more embodiments of the present disclosure to provide an antistatic optically clear adhesive with sufficient surface conductivity and sufficient bulk conductivity to dissipate a static charge generated when a release liner supporting the adhesive is removed from the adhesive at high speed. In addition, the adhesives of one or more embodiments of the present disclosure are reworkable such that a polarizer attached with this adhesive can be cleanly removed from LCD glass, such as will be useful when lamination defects are observed after an LCD assembly process. Additionally, the OCA adhesive strength should not exceed the tear strength of the polarizer, so the polarizer and adhesive can be removed together without tearing the polarizer. The adhesives of one or more embodiments of the present disclosure adhere sufficiently to prevent undesirable delamination of an LCD polarizer, minimize bubbles between the polarizer and the glass, and allow only minimal polarizer shrinkage following environmental cycling tests. In addition, the adhesives of one or more embodiments of the present disclosure do not adversely interact with LCD polarizers.

Other features and advantages will be apparent from the following detailed description and the claims. The above summary is not intended to describe each illustrated embodiment or every implementation of the present disclosure. The detailed description that follows more particularly exemplifies certain presently preferred embodiments using the principles disclosed herein.

### DETAILED DESCRIPTION

All numbers are herein assumed to be modified by the term “about.” The recitation of numerical ranges by endpoints includes all numbers in that range (e.g., 1 to 5 includes 1, 1.5, 2, 2.75, 3, 3.80, 4, and 5). Percentages of material amounts are by weight unless otherwise indicated.

The present disclosure provides an optically clear display-grade adhesive comprising a crosslinked acrylic polymer, a dissociable, organic-soluble salt, and optionally a non-hydrophilic plasticizer, wherein the optically clear display-grade adhesive is pressure-sensitive, and electrostatically dissipative.

### Pressure Sensitive Adhesive

Any suitable pressure sensitive adhesive composition can be used for this invention. In specific embodiments, the adhesive is pressure sensitive and optically clear. Pressure sensitive adhesives (PSAs) are well known to possess properties such as: (1) aggressive and even permanent tack at room temperature, (2) adherence to a substrate with no more than finger pressure, (3) sufficient ability to hold onto an adherend, and/or (4) sufficient cohesive strength to be removed cleanly from the adherend. Furthermore, the pressure sensitive adhesive can be a single adhesive or a combination of two or more pressure sensitive adhesives.

An adhesive may be considered to be optically clear if it exhibits an optical transmission of at least about 90%, or even higher, and a haze value of below about 5%, or even lower, as measured on a 25 micron (μm) thick sample in the manner described below. Pressure sensitive adhesives useful in the present invention include, for example, polyvinyl ethers, and poly (meth)acrylates (including both acrylates and methacrylates).

Useful alkyl acrylates (i.e., acrylic acid alkyl ester monomers) include linear or branched monofunctional acrylates or methacrylates of non-tertiary alkyl alcohols, the alkyl groups of which have from 1 up to 14 and, in particular, from 1 up to 12 carbon atoms. Useful monomers include butyl(meth)acrylate, 2-ethylhexyl(meth)acrylate, ethyl(meth)acrylate, methyl(meth)acrylate, n-propyl(meth)acrylate, isopropyl(meth)acrylate, pentyl(meth)acrylate, n-octyl(meth)acrylate, isooctyl(meth)acrylate, isononyl(meth)acrylate and 2-methyl-butyl(meth)acrylate.

In one embodiment, the pressure sensitive adhesive is based on at least one poly(meth)acrylate (e.g., is a (meth)acrylic pressure sensitive adhesive). Poly(meth)acrylic pressure sensitive adhesives are derived from, for example, at least one alkyl(meth)acrylate ester monomer such as, for example, isooctyl acrylate, isononyl acrylate, 2-methyl-butyl acrylate, 2-ethyl-hexyl acrylate and n-butyl acrylate, isobutyl acrylate, hexyl acrylate, n-octyl acrylate, n-octyl methacrylate, n-nonyl acrylate, isoamylacrylate, n-decyl acrylate, isodecyl acrylate, isodecyl methacrylate, and dodecyl acrylate; and at least one optional co-monomer component such as, for example, (meth)acrylic acid, N-vinyl pyrrolidone, N-vinylcaprolactam, N,N-dimethyl(meth)acrylamide, N-isopropyl(meth)acrylamide, (meth)acrylamide, isobornyl acrylate, 4-methyl-2-pentyl acrylate, a hydroxyalkyl(meth)acrylate, a vinyl ester, a polystyrene or polymethylmethacrylate macromer, alkyl maleates and alkyl fumarates (based, respectively, on maleic and fumaric acid), or combinations thereof.

The OCAs of various embodiments can be removable and/or reworkable, or relatively permanent such that removal of the OCA damages an adhered substrate. Such OCAs are derived from at least one alkyl(meth)acrylate and optionally a polar monomer, such as acrylic monomer containing carboxylic acid, amide, urethane, urea, or hydroxyl functional groups. Weak polar monomers like N-vinyl lactams may also be included. Combinations of these polar monomers may also be used. In general, the polar monomer content in the OCA is less than about 5% based on total polymer content. Preferably, the polar monomer content is about 3% or less. Those polar monomers that are only weakly polar may be incorporated at levels below about 30%, and preferably below about 20%, or even lower.

In certain embodiments, the poly(meth)acrylic pressure sensitive adhesive is derived from between about 0 and about 6% of acrylic acid and between about 100% and about 96% of at least one of isooctyl acrylate, 2-ethyl-hexyl acrylate or n-butyl acrylate composition. One specific embodiment for the present invention is derived from a composition of between about 1% and about 2% acrylic acid and between about 99% and about 98% of at least one of isooctyl acrylate, 2-ethyl-hexyl acrylate or n-butyl acrylate. One specific embodiment is derived from about 1% to about 2% acrylic acid, about 99% to about 98% of a combination of n-butylacrylate and methylacrylate.

In other embodiments, the poly(meth)acrylic pressure sensitive adhesive is derived from a composition of between about 0 and about 4% of hydroxyalkyl(meth)acrylate and between about 100% and about 96% of at least one of isooctyl acrylate, 2-ethyl-hexyl acrylate or n-butyl acrylate. One specific embodiment is derived from a composition of between about 1% and about 2% hydroxyalkyl(meth)acrylate and between about 99% and about 98% of at least one of isooctyl acrylate, 2-ethyl-hexyl acrylate or n-butyl acrylate. One specific embodiment is derived from a composition of about 1% to about 2% hydroxyalkyl(meth)acrylate, and about 99% to about 98% of a combination of n-butylacrylate and methylacrylate.

In some embodiments, the pressure-sensitive adhesive components may be blended to form an optically clear mixture. One or more of the polymeric components may be independently crosslinked or crosslinked with a common cross-linker. Such cross-linkers include thermal crosslinkers which are activated during the drying step of preparing solvent coated adhesives. Such thermal cross-linkers may include multifunctional isocyanates, aziridines and epoxy compounds. In addition, ultraviolet, or “UV”, initiators may be used to cross-link the pressure sensitive adhesive. Such UV initiators may include benzophenones and 4-acryloxybenzophenones.

The pressure sensitive adhesive may be inherently tacky. If desired, tackifiers may be added to a base material to form the pressure sensitive adhesive. Useful tackifiers include, for example, rosin ester resins, aromatic hydrocarbon resins, aliphatic hydrocarbon resins, and terpene resins. In general, light-colored tackifiers selected from hydrogenated rosin esters, terpenes, or aromatic hydrocarbon resins are preferred.

Other materials can be added for special purposes, including, for example, oils, plasticizers, antioxidants, UV stabilizers, pigments, curing agents, polymer additives, thickening agents, dyes, chain transfer agents, and other additives provided that they do not significantly reduce the optical clarity of the pressure sensitive adhesive. In some embodiments the plasticizer is provided in an effective amount to facilitate salt dissociation and ion mobility for static dissipation properties in the adhesive, for example an amount greater than about 0.01 parts by weight (pbw) based on 100 pbw of acrylic adhesive, optionally an amount greater than about 0.10 pbw and in some embodiments an amount greater than about 1.0 pbw may be used. In addition, in some embodiments the plasticizer may be provided in an effective amount, for example, an amount less than about 20 pbw and optionally an amount less than about 10 pbw. In certain embodiments, the plasticizer may facilitate salt dissociation and ion mobility in the adhesive. In some embodiments, the plasticizer is selected from acrylic soluble plasticizers, including phosphate esters, adipate esters, citrate esters, phthalate esters, phenyl ether terminated oligoethylene oxides. In general, non-hydrophilic plasticizers are preferred, such as those free of alkylene oxide repeat units. Non-hydrophilic plasticizers do not take up appreciable moisture from the atmosphere at high humidity and elevated temperatures. For example, non-hydrophilic plasticizers (such as used in the included examples) typically show 0.01% or less solubility in water at room temperature, more preferably 0.001% or less.

### Antistatic Agent

An antistatic agent operates by removing static charge or by preventing build up of such charge. Antistatic agents, or organic-soluble and dissociable salts, useful in the present invention include non-polymeric and polymeric organic salts. Non-polymeric salts have no repeat units. Generally, the antistatic agent comprises an amount less than about 10% of the antistatic pressure sensitive adhesive and optionally an amount less than about 5% of the antistatic PSA. In addition, the antistatic agent comprises an amount greater than about 0.5% of the antistatic PSA and optionally an amount greater than about 1.0% of the antistatic PSA. These materials are organic-soluble in the selected system even when not soluble in every system. The dissociable salts separate into charge-carrying ions in the selected system.

When combined with the dissociation enhancing plasticizer, the anti-static agent can be used at 4% or less, significantly reducing the cost of the OCA and reducing any adverse interaction that may exist between the anti-static agent and the polarizer. In some preferred embodiments, the antistatic salt is a non-hydrophilic compound. Such non-hydrophilic antistatic compounds tend to reduce the dependence of the performance of the antistatic compound on humidity while improving compatibility with the pressure sensitive adhesive. In some embodiments, it is preferred that both the anion and the cation are organic in that they both include carbon containing groups and are nominally free of metal ions. Generally, the antistatic agent is added in an amount that will not adversely affect the desired optical clarity of the antistatic pressure sensitive adhesive. In certain embodiments, the antistatic agent is loaded into the antistatic pressure sensitive adhesive between about 0.05% and about 10%, at any number within that range (e.g., 7%, 1.6%, etc.).

The proper antistatic agent for a given adhesive system is chosen by balancing properties in the cations and anions that make up the antistatic agents to achieve solubility in particular cured adhesive formulations. Thus the anti-static agents are organic-soluble.

One specific class of ionic salts useful in preparing the antistatic agent of the invention is the class of compounds represented by the general formula:

(R₁)ₜ₋ᵥG⁺[(CH₂)_{q}OR₂]ᵥX⁻ (I)

wherein each R₁ comprises alkyl, alicyclic, aryl, alkalicyclic, alkaryl, alicyclicalkyl, aralkyl, aralicyclic, or alicyclicaryl moieties, wherein the moieties may comprise one or more heteroatoms, e.g., nitrogen, oxygen, or sulfur, or may comprise phosphorus, or a halogen (and thus can be fluoro-organic in nature); each R₂ comprises hydrogen or the moieties described above for R₁; G is nitrogen, sulfur or phosphorous; if G is sulfur then t is 3, if G is nitrogen or phosphorous then t is 4; v is an integer of 1 to 3 if G is sulfur, or an integer of 1 to 4 if G is nitrogen or phosphorous; q is an integer of 1 to 4; and X is a weakly coordinating organic anion, such as a fluoro-organic anion. R₁ is preferably alkyl, and R₂ is preferably hydrogen, alkyl, or acyl (more preferably, hydrogen or acyl; most preferably, hydrogen). More detail is found in U.S. Patent Publication 2003/0114560, which is herein incorporated by reference.

Another specific class of ionic salts that are useful in preparing the antistatic agent is represented by formula II:

(R₃)₄G′⁺X⁻ (II)

where each of the R₃, independently, comprises alkyl, alicyclic, aryl, alkaryl or aralkyl moieties, where G′ is N or P, and where X⁻ is a weakly coordinating organic anion.

Suitable weakly coordinating organic anions have a conjugate acid that is at least as acidic as a hydrocarbon sulfonic acid (for example, a hydrocarbon sulfonic acid having from 1 to about 20 carbon atoms; such as, an alkane, aryl, or alkaryl sulfonic acid having from 1 to about 8 carbon atoms; and in specific examples, methane or p-toluene sulfonic acid; most preferably, p-toluene sulfonic acid). Generally, the conjugate acid is a strong acid. For example, the Hammett acidity function, H, of the neat conjugate acid of the anion is less than about −7 (preferably, less than about −10).

Examples of suitable weakly coordinating anions include organic anions such as alkane, aryl, and alkaryl sulfonates; alkane, aryl, alkaryl sulfates; fluorinated and unfluorinated tetraarylborates; and fluoroorganic anions such as fluorinated arylsulfonates, perfluoroalkanesulfonates, cyanoperfluoroalkanesulfonylamides, bis(cyano)perfluoroalkanesulfonylmethides, bis(perfluoroalkanesulfonyl)imides, cyano-bis-(perfluoroalkanesulfonyl)methides, bis(perfluoroalkanesulfonyl)methides, and tris(perfluoroalkanesulfonyl)methides; and the like.

In addition to those mentioned above, useful cations include, for example, alkali metal cations such as Li+, Na+, and K+.

Useful ionic salts can be prepared by any known method or obtained commercially. For example, ionic salts may be prepared by ion exchange or metathesis reactions known in the art. More specifically, a precursor onium salt can be combined with the precursor metal salt or the corresponding acid of a weakly coordinating anion in aqueous solution. Upon combining, the desired product precipitates or can be preferentially extracted into a solvent. The product can be isolated by filtration or by liquid/liquid phase separation, can be washed with water to completely remove byproduct metal halide salt or hydrogen halide, and that can be dried thoroughly under vacuum to remove all volatiles. Similar metathesis reactions can be conducted in organic solvents, rather than in water, and, in this case, the salt byproduct preferentially precipitates, while the products all remain dissolved in the organic solvent (from which they can be isolated using standard techniques). More detail is found in U.S. Pat. No. 6,372,829, especially around column 8 lines 3-28, which disclosure is herein incorporated by reference. An example of a useful commercially-available salt is 3M™ Fluorad™ HQ-115, lithium(bis)trifluoromethanesulfonimide, from 3M Company.

### Antistatic Pressure Sensitive Adhesive

One embodiment of the present disclosure is an acrylic based pressure sensitive adhesive with a salt with an organo-onium cation from group IVb to VIIb, preferably from group Vb to VIb, most preferably from group Vb, and an organic anion of a strong Bronsted acid wherein the salt or its ions are not migrating to the surface of the acrylic pressure sensitive adhesive to the point where they interfere with adhesion. Another embodiment of the present disclosure is an acrylic-based PSA with an organic salt with a tetraalkyl ammonium cation and an organic anion of a strong Bronsted acid. Yet another embodiment of the present disclosure is an acrylic-based PSA with a salt with an inorganic cation and an organic anion of a strong Bronsted acid.

In some embodiments, the adhesive comprises a salt of anions and cations that are not surface active, in that the salt components do not reduce adhesion to a glass substrate below 50% of the peak adhesion level over several hours to several days or even longer. In some embodiments, the adhesive can be adhered to a polarizer film and remain removable from a glass surface after contact with the surface for at least about 7 days at a temperature of at least about 22° C. and a relative humidity of about 50%. These conditions can vary independently, for example, from about 1 to about 30 days, a temperature of about 20 to about 30° C., and a relative humidity from about 20% to about 90%. In some embodiments, the disclosed adhesives are substantially inert to a polarizing film, such that they provide sufficient initial tack and adhesion for the intended purpose, yet remain removable after time and/or do not build adhesion to an adverse level under the desired exposure conditions.

In some embodiments, the antistatic pressure sensitive adhesive is prepared by forming a PSA and blending it with the antistatic agent to create an antistatic blend. The pressure sensitive adhesive is formed by blending the pressure sensitive adhesive components, either before polymerization or after polymerization. In some embodiments, the pressure sensitive adhesive components are further blended with a photoinitiator. Suitable photoinitiators include, for example, Irgacure 651, from Ciba Specialty Chemicals, Tarrytown, N.Y. The monomers of the pressure sensitive adhesive are first degassed in nitrogen and then irradiated with an appropriate radiation source, e.g., an ultraviolet lamp for a time effective to form a syrup. The syrup generally has a viscosity of from about 200 centipoise (0.2 Pa-s) to about 3000 centipoise (3 Pa-s). The syrup is then mixed with anti-static agent, crosslinker (multifunctional acrylates to crosslink the syrup), and optional plasticizer. The resulting adhesive composition is coated on a release liner and further exposed to UV irradiation to yield a fully polymerized, optically clear adhesive.

The antistatic agent is loaded into the syrup at a weight percentage of less than about 10%, and optionally less than about 5%, or even lower. In addition, the antistatic agent is loaded into the syrup at a weight percentage of greater than about 0.5%, and optionally greater than about 1.0%, or even greater. The antistatic agent and the syrup may be blended using any known means, such as shaking, stirring or mixing. The combination of the syrup and the antistatic agent is such that the resulting antistatic pressure sensitive adhesive has desirable optical properties upon suitable curing.

In solvent-based pressure sensitive adhesives, the PSA is coated from solution in an organic solvent and then dried. The solvent-based PSA is cross-linked during the drying process, or in some cases it may be crosslinked after the drying step. Such cross-linkers include thermal cross-linkers which are activated during the drying step of preparing solvent coated adhesives. Such thermal cross-linkers may include multifunctional isocyanates, aziridines and epoxy compounds. In addition, UV-triggered cross-linkers may be used. Such UV-triggered cross-linkers may include benzophenones and 4-acryloxybenzophenones.

To further optimize adhesive performance of the optically clear adhesive, adhesion promoting additives, such as silanes and titanates may also be incorporated into the optically clear adhesives of the present disclosure. Such additives can promote adhesion between the adhesive and the substrates, like the glass and cellulose triacetate of an LCD by coupling to the silanol, hydroxyl, or other reactive groups in the substrate. The silanes and titanates may have only alkoxy substitution on the Si or Ti atom connected to an adhesive copolymerizable or interactive group. Alternatively, the silanes and titanates may have both alkyl and alkoxy substitution on the Si or Ti atom connected to an adhesive copolymerizable or interactive group. The adhesive copolymerizable group is generally an acrylate or methacrylate group, but vinyl and allyl groups may also be used. Alternatively, the silanes or titanates may also react with functional groups in the adhesive, such as a hydroxyalkyl(meth)acrylate. In addition, the silane or titanate may have one or more group providing strong interaction with the adhesive matrix. Examples of this strong interaction include, hydrogen bonding, ionic interaction, and acid-base interaction.

In some embodiments, it is preferred to minimize or even eliminate one or more of plasticizers, chelating agents, and multivalent metallic ions. In other embodiments, an inorganic/organic salt combination, such as HQ-115 described above, can be used with a PSA described herein and optionally a non-hydrophilic plasticizer, and optionally without chelating agents. In other embodiments, when an alkali metal cation is used in the salt, a non-hydrophilic plasticizer also is used.

In some embodiments, chelating agents, such as those having acceptable solubility in suitable organic solvents (e.g., ethylacetate, toluene, methylethylketone, acetone, or alcohols), and acceptable compatibility with the PSAs are selected. Suitable examples of a chelating agent include those compounds having oxalate group, diamine group, polycarboxylic group, or β-ketone group, which can be used alone or in a mixture thereof. More specifically, examples include diethyloxalate, dimethyloxalate, dibutyloxalate, di-tert-butyloxalate, or bis(4-methylbenzy-1)oxalate; ethylenediamine, 1,2-diaminopropane, diaminobutane, ethylenediamine-N,N,N′,N′-tetraacetic acid (EDTA), N,N,N′,N″,N″-diethylenetriaminepentaacetic acid (DTPA), 1,4,7,10-tetraazacyclododecane-N,N′,N″,N′″-tetraacetic acid (DOTA), 1,4,7,10-tetraazacyclododecane-N,N′,N″-triacetic acid (DO3A), trans(1,2)-cyclohexano diethylenetriaminepentaacetic acid, and N,N-biscarboxymethylglycine. It will be appreciated by one skilled in the art that such chelating agents can be used together with metal salts to increase the level of salts includable into a PSA, however, such combinations change the basic character of the PSA and thus are not suitable for all applications. Would like to discuss this paragraph.

In some embodiments, one or more ester plasticizer(s) having one or more ether bonds can be used, for example, diethylene glycol di-2-ethylhexonate, tetraethylene glycol di-2-ethylhexonate, polyethylene glycol di-2-ethylhexonate, triethylene glycol diethylbutylate, polyethylene glycol diethylbutylate, polypropylene glycol diethylhexonate, triethylene glycol dibenzonate, polyethylene glycol dibenzonate, polypropylene glycol dibenzonate, and polyethylene glycol-2-ethylhexonate benzonate. In other embodiments, such plasticizers are not used. Would like to discuss this paragraph.

In some embodiments, the PSA lacks one or more of a chelating agent, hydrophilic plasticizer, and quaternary ammonium salt, which materials previously have been reported as useful in PSAs.

The adhesive composition may be easily coated upon suitable flexible backing materials by any known coating technique to produce adhesive coated sheet materials. The flexible backing materials may be any materials conventionally used as a tape backing, optical film, release liner or any other flexible material. Typical examples of flexible backing materials employed as tape backing that may be useful for the adhesive compositions include those made of paper, plastic films such as polypropylene, polyethylene, polyurethane, polyvinyl chloride, polyester (e.g., polyethylene terephthalate), cellulose acetate, and ethyl cellulose. Some flexible backing may have coatings, for example a release liner will be coated with a low adhesion component, such as silicone. In some embodiments, a second release liner may be laminated to the exposed face of an antistatic adhesive which has been coated on a first release liner. Either the first release liner or the second release liner or both may exhibit a degree of electrostatic dissipation.

The pressure sensitive adhesives of the present disclosure may be applied directly to one or both sides of an optical element such as a polarizer. The polarizer may include additional layers such as an anti-glare layer, a protective layer, a reflective layer, a phase retardation layer, a wide-angle compensation layer, and a brightness enhancing layer. In some embodiments, the pressure sensitive adhesives of the present disclosure may be applied to one or both sides of a liquid crystal cell. It may also be used to adhere a polarizer to a liquid crystal cell.

The pressure sensitive adhesives of the present invention may be coated by any variety of known coating techniques such as roll coating, spray coating, knife coating, die coating and the like.

The resulting pressure sensitive adhesive has desirable antistatic properties. Generally, the surface resistivity is less than 1×10¹³ ohms/square. In some embodiments, the surface resistivity is less than 1×10¹¹ ohms/square. Additionally, the PSA has antistatic properties in both low and high humidity conditions without resulting in any deterioration in the adhesive itself or in the antistatic properties.

The bulk resistivity or electrical resistance of the adhesives disclosed is generally below about 1×10¹¹ ohm-cm as measured through the thickness (also called the “z-direction”).

The bulk resistivity or electrical resistance of the adhesives disclosed is generally below about 1×10¹¹ ohm-cm as measured in the plane. As used herein, the plane of the adhesive is the x-y direction or that direction perpendicular to the adhesive thickness. In some embodiments, the electrical resistance (Ohms) in the z- and/or x-y direction is much lower than 1×10¹¹ ohm-cm.

Water absorption into the pressure sensitive adhesive may cause bubbling in the adhesive, change the anti-static performance, or create haze. Organic-soluble salts, particularly non-hydrophilic, organic-soluble salts, absorb less water, and therefore remain stable in a variety of environments. Similarly, non-hydrophilic plasticizers absorb little or no water, providing an optically, clear and environmentally stable adhesive. Generally it is preferred that the surface resistivity at low humidity (23% humidity at 23° C.) is within a factor of two of the surface resistivity at high humidity (50% humidity at 20° C.).

Additionally, organic anti-static agents (as discussed above) are available and stable in antistatic PSA's of the present disclosure. Inorganic and metal cation salts may tend to precipitate and phase separate from the pressure sensitive adhesive matrix in certain conditions. This is especially true in low humidity or in the absence of solubilizing components, such as polyethylene oxide containing plasticizers and metal ion chelating plasticizers or additives. For this reason, organic cations and anions are often preferred.

The antistatic pressure sensitive adhesive of the present disclosure exhibits desirable optical properties, for example the disclosed adhesives have a higher luminous transmission and lower haze than a selected substrate. Therefore, a PSA article of the present disclosure will have substantially the same luminous transmission and haze as the backing alone. In other embodiments, the antistatic PSA will have a lower opacity than the substrate, for example less than 1%, and in specific embodiments less than 0.6%. In a multiple layered article, each layer generally contributes to a decrease in luminous transmission.

The antistatic pressure sensitive adhesive of the present invention, when added to a multilayered structure, will generally not reduce optical properties further. For example, a sheet of polyethylene terephthalate 25 μm thick having a luminous transmission of greater than 88% and a haze of less than 5%, together with a PSA of the present disclosure is upon this polyethylene terephthalate backing will also have a luminous transmission of greater than 88% and a haze of less than 5%. In such embodiments, the adhesive will have a luminous transmission of greater than 88%, e.g., 89% or higher. In certain embodiments, the haze is less than 4%, and in some embodiments the haze is less than 2%. The opacity of the antistatic pressure sensitive adhesive of some embodiments is generally less than 1%, more preferably below about 0.6%. These optical features can be measured using a microscope slide measured without, and then with, the adhesive laminated to the slide and comparing the results.

In general, a pressure sensitive adhesive applied to an LCD may be considered reworkable if the LCD is not substantially damaged when the adhesive is removed and no significant amount of adhesive residue remains on the LCD. Reworkable pressure sensitive adhesives typically exhibit a 180° peel adhesion from glass of at least about 2, at least about 3, or even at least about 5 (all in N/dm after 1 minute room temperature dwell). The shear strength of the resulting antistatic pressure sensitive adhesive is at least 1,000 minutes. The reworkable antistatic pressure sensitive adhesive exhibits a 180° peel adhesion from glass of no more than about 75, 65, 50, 40, 30, or even lower (all in N/dm after 1 hour dwell at 65° C.).

It is noted that poly(alkylene oxide) plasticizers are inherently hydrophilic, and therefore OCA's containing poly(alkylene oxide) are sensitive to moisture and show low durability in a high temperature and high humidity environment. Thus, adhesives containing such materials are less suitable for LCD applications.

Because the antistatic OCA of the present disclosure can be in direct contact with the polarizer, it is essential that no components in the adhesive adversely interact with the triacetyl cellulose (TAC) outer layer or any other layer of the polarizer sufficiently to cause degradation that undesirably diminishes the polarizer performance. In addition, the adhesives of the present invention do not interact with the iodine or orientation in the polarizer causing any bleaching of the polarizer.

This invention is useful in antistatic pressure sensitive adhesive applications, for example, in LCD assembly.

Objects and advantages of the present invention are further illustrated by the following examples, and the particular materials and amounts thereof recited in these examples, as well as other conditions and details, should not be construed to unduly limit this invention.

### Examples

Where not otherwise specified, materials were available from chemical supply houses, such as Aldrich, Milwaukee, Wis.

### Materials

| Name | Source |
|---|---|
| Lithium Perchlorate | Aldrich Chemical, |
| Li⁺ ClO₄⁻ | Milwaukee, WI |
| Potassium nonafluorobutanesulfonate, | 3 M Company, |
| [K⁺ (⁻O₃SC₄F₉)] (3 M FR2225) | St Paul, MN |
| Lithium bis(trifluoromethanesulfonyl)imide, | 3 M Company |
| L⁺[⁻N(SO₂CF₃)₂] (3 M HQ-115) | |
| Pycal ® 94, Polyoxyethylene Aryl Ether | ICI Americas, Inc., |
| | Wilmington, DE |
| Santicizer ® 141, 2-Ethylhexyldiphenyl Phosphate | Ferro Corp., |
| | Walton Hills, OH |
| Vazo ® 67, 2,2-azobis-(2-methylbutanenitrile) 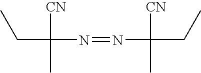 | DuPont, Wilmington, DE |
| Desmodur L 75, Aromatic polyisocyanate | Bayer Material Science, |
| | Pittsburgh, PA |
| Bis-amide cross-linker, | Prepared as described in U.S. |
| 1.1′-isophthaloyl-bis(2-methylaziridine) | Pat. No. 4,418,120 |
| Desmodur N 3300A, Aliphatic polyisocyanate | Bayer Material Science, |
| resin | Pittsburgh, PA |

### Preparation of Tetrabutylammonium nonafluorobutanesulfonate [(C₄H₉)₄N⁺][(C₄F₉SO₃⁻)]

Tetrabutylammonium nonafluorobutanesulfonate was prepared from the reaction of tetrabutylammonium chloride and potassium nonafluorobutanesulfonate (FR2225, 3M Company, St Paul, Minn.) by the general procedure described in U.S. Pat. No. 6,372,829 B1 at column 8, lines 3-28.

### Preparation of dodecylmethylbis-(2-hydroxyethyl)ammonium bis(trifluoromethanesulfonyl)imide. [C₁₂H₂₅N⁺(CH₃)(CH₂CH₂OH)₂][⁻N(SO₂CF₃)₂]

Dodecylmethylbis-(2-hydroxyethyl)ammonium bis(trifluoromethanesulfonyl)imide was prepared as follows: to 36.38 g (0.127 mol) HQ˜115 in 70 mL of water was added 55.0 g (0.127 mol) of a 75% solids solution of ETHOQUAD C/12 (323.5 g/mole) in water with stirring. After 2 h at room temperature (25° C.), the reaction was extracted with 70 mL methylene chloride. The methylene chloride layer was washed with 40 mL water, and then concentrated under aspirator vacuum at 60-120° C. for 3 h to yield 70.54 g (94.3%) of a viscous, clear, light-brown product.

### Preparation of Tris-(n-butyl)methylammonium bis(trifluoromethanesulfonyl)imide. [(C₄H₉)₃(CH₃)N⁺][⁻N(SO₂CF₃)₂]

Tris(n-butyl)methylammonium bis(trifluoromethanesulfonyl)imide was prepared from tributylmethylammonium chloride and lithium bis(trifluoromethanesulfonyl)imide (3M HQ115) by the general procedure described in U.S. Pat. No. 6,372,829 B1 at column 8, lines 3-28.

### Synthesis of a Representative PSA Solution

A one-liter bottle was charged with VAZO67 (0.2 g), n-butyl acrylate (BA) (98 g), 4-hydroxy butyl acrylate (4HBA) (2 g) and ethyl acetate (150 g). Nitrogen was bubbled into the solution for ten minutes. The bottle was sealed under the nitrogen atmosphere and was placed in a water bath heated to 58° C. for 24 h during which time the bottle was tumbled in the water bath. Finally, ethyl acetate (210 g) and toluene (40 g) were added to the bottle to yield a 20% solids solution.

### Test Methods

### Peel Adhesion Testing

The peel adhesion was tested by laminating the adhesive sample (width=2.54 cm) onto a primed polyester film (38 μm) removing the original release liner from the adhesive and then laminating the adhesive to an LCD glass panel. After 1 minute of contact time, the adhesive sample with the polyester backing, was peeled at a 180 degree angle and a speed of 30 cm/min. The force required to remove the adhesive sample is displayed in the column labeled Initial Glass Adhesion in the Table of Results. Unless otherwise noted, the sample was removed from the LCD glass without leaving any residue on the glass. Some samples of the polyester backed adhesive laminated on the LCD glass were placed in an oven at 65° C. for one hour. The sample was allowed to cool to room temperature and the peel adhesion test as described above was repeated. The change in the peel force from the initial adhesion value and the 1 hour high temperature exposure value is indicative of the adhesion build and longer term removability of the tape. Unless, otherwise noted, the adhesive removed cleanly from the LCD glass panel after this exposure to high temperature.

### Durability Test

An adhesive sample was laminated to a film “polarizer”, the original release liner was removed and the adhesive was laminated to LCD glass. The laminated sample was placed in an oven maintained at 65° C. and 90% relative humidity for up to one week. The sample was occasionally removed from the oven and visually inspected for defects. If no defects were observed, the sample was rated “OK” and then the sample was immediately returned to the oven. Notations were made for any samples that showed the formation of dimples, visible bubbles, located at either the adhesive interface or in the adhesive, or showed any debonding of the polarizer from the LCD glass, resulting in edge lifting or complete detachment of the polarizer/adhesive/LCD glass assembly. While dimples and bubbles can generally be further improved by fine tuning the adhesive formulation, delamination is not an acceptable failure mode. The OCA also was observed for visible light transmission and rated “Clear” if no changes were observed or “Hazy” if the adhesive degraded or clouded from the original appearance.

### Surface Resistance

The surface resistance of an adhesive sample was measured according to ASTM D257. A specimen of the adhesive was placed between the two electrodes of a Keithly 8009 test apparatus (Keithley Instruments Inc., Cleveland, Ohio) and exposed to a potential of 500 volts for 60 seconds after conditioning the sample at 23° C. and 23% relative humidity for 24 hours. The surface resistance was recorded immediately after exposure to the 500 volt potential.

### DC Volume Resistivity Test

A 25 μm thick sample of adhesive was coated onto an aluminum substrate that was approximately 50 mm in diameter. Then two parallel and concentric aluminum electrodes, each with a diameter 9.41 mm, were placed, one each, on the opposite surfaces of the adhesive/aluminum sample. The DC Resistance of the sample was measured three separate times with a DC Keithly 6515A Electrometer (Keithley Instruments, Cleveland, Ohio). The volume resistivity at 100 volts DC was calculated using the electrode diameter, the adhesive thickness and the measured resistance between the two electrodes.

### Haze and Transmission

A 25 μm thick sample of the adhesive was laminated to a 25 μm thick Melinex™ 454 polyester film (DuPont Co., Wilmington, Del.) in a manner to assure that no air bubbles are trapped between the film and the adhesive layer. A 75 mm by 50 mm Plain Micro Slide (Dow Corning, Midland, Mich.), that had been wiped three times with isopropanol, was laminated to the adhesive sample using a hand roller to assure no air bubbles were trapped between the adhesive and the glass slide. The Percent (%) Transmission and Haze were measured using a Model 8870 BYK Gardner TCS Plus Spectrophotometer (Columbia, Md.). The background measurement was made with a sandwich of the Melinex 454 and microscope slide. The % Transmission and the Haze of the adhesive sample was then obtained directly on the film/adhesive/glass laminate in the spectrophotometer.

### Polarizer Bleaching Test

Adhesive samples were laminated to two pieces of polarizer film. The laminated samples were placed in an oven maintained at 65° C. and 90% relative humidity for one week. These samples were placed one on top of the other with their axes of polarization at 90 degrees. If the light was observed to leak through the two samples, the adhesive/polarizer combination was judged unstable. Stable adhesive/polarizer combinations did not allow light to leak through the two samples.

TABLE 1
Pressure Sensitive Adhesives (Mole Ratios)

| | IOA | AA | BA | AcM | 4HBA | EA | MA | HEA |
|---|---|---|---|---|---|---|---|---|
| PSA 1 | 98 | 2 | — | — | — | — | — | — |
| PSA 2 | — | 2 | 98 | — | — | — | — | — |
| PSA 3 | 96 | — | — | 4 | — | — | — | — |
| PSA 4 | — | — | 96 | — | 4 | — | — | — |
| PSA 5 | — | — | 88 | — | — | 10 | — | 2 |
| PSA 6 | — | — | 98 | — | — | — | — | 2 |
| PSA 7 | — | — | 58 | — | — | — | 40 | 2 |
| PSA 8 | — | — | 88 | — | — | — | 10 | 2 |

IOA = Isooctylacrylate,
AA = Acrylic Acid,
BA = Butylacrylate,
AcM = Acrylamide,
4HBA = 4-hydroxy-butylacrylate,
EA = Ethylacrylate,
MA = Methylacrylate,
HEA = 2-hydroxy-ethylacrylate,
“—” indicates not used

### Preparation of Antistatic OCA Samples

A coating solution was prepared by placing a PSA solution and the desired amounts of crosslinker, antistatic agent, and optionally a plasticizer in a jar. The jar was placed on a mechanical roller for thirty minutes. The solution was coated on a siliconized polyester release liner and the coated sample was heated for 30 minutes in a forced air oven set at 70° C. The final adhesive sample was approximately 25 μm thick.

TABLE 2
Adhesives

| Ex. | PSA | Organic-soluble Salt (PPH) | Plasticizer (PPH) | Crosslinker (PPH) |
|---|---|---|---|---|
| 1 | PSA 5 | [C₁₂H₂₅N⁺(CH₃)(CH₂CH₂OH)₂][⁻N(SO₂CF₃)₂] | — | Desmodur N 3300 |
| | | (10) | | (0.2) |
| 2 | PSA 5 | [(C₄H₉)₃(CH₃)N⁺][⁻N(SO₂CF₃)₂] (10) | — | Desmodur N 3300 |
| | | | | (0.2) |
| 3 | PSA 6 | [(C₄H₉)₃(CH₃)N⁺][⁻N(SO₂CF₃)₂] (5) | — | Desmodur N 3300 |
| | | | | (0.2) |
| 4 | PSA 6 | [(C₄H₉)₃(CH₃)N⁺][⁻N(SO₂CF₃)₂] (5) | Santicizer 141 (1) | Desmodur N 3300 |
| | | | | (0.2) |
| 5 | PSA 6 | [(C₄H₉)₃(CH₃)N⁺][⁻N(SO₂CF₃)₂] (5) | Santicizer 141 (3) | Desmodur N 3300 |
| | | | | (0.2) |
| 6 | PSA 7 | [(C₄H₉)₃(CH₃)N⁺][⁻N(SO₂CF₃)₂] (2.5) | Santicizer 141 | Desmodur L 75 (0.15) |
| | | | (10) | |
| 7 | PSA 7 | [(C₄H₉)₃(CH₃)N⁺][⁻N(SO₂CF₃)₂] (2.5) | Santicizer 141 | Desmodur L 75 (0.15) |
| | | | (15) | |
| 8 | PSA 8 | [(C₄H₉)₃(CH₃)N⁺][⁻N(SO₂CF₃)₂] (5) | — | Desmodur L 75 (0.1) |
| 9 | PSA 8 | [(C₄H₉)₃(CH₃)N⁺][⁻N(SO₂CF₃)₂] (1.5) | Santicizer 141 (3) | Desmodur L 75 (0.1) |
| 10 | PSA 1 | Li⁺[⁻N(SO₂CF₃)₂] (15) | — | Bis-amide (0.1) |
| 11 | PSA 2 | Li⁺[⁻N(SO₂CF₃)₂] (15) | — | Bis-amide (0.1) |
| 12 | PSA 4 | Li⁺[⁻N(SO₂CF₃)₂] (10) | — | Desmodur L 75 (0.2) |
| 13 | PSA 5 | Li⁺[⁻N(SO₂CF₃)₂] (10) | — | Desmodur N 3300 |
| | | | | (0.2) |
| 14 | PSA 4 | Li⁺[⁻N(SO₂CF₃)₂] (5) | — | Desmodur L 75 (0.2) |
| 15 | PSA 4 | Li⁺[⁻N(SO₂CF₃)₂] (5) | Santicizer 141 (5) | Desmodur L 75 (0.2) |
| 16 | PSA 6 | Li⁺[⁻N(SO₂CF₃)₂] (5) | Santicizer 141 (1) | Desmodur N 3300 |
| | | | | (0.2) |
| 17 | PSA 6 | Li⁺[⁻N(SO₂CF₃)₂] (5) | Santicizer 141 (3) | Desmodur N 3300 |
| | | | | (0.2) |
| 18 | PSA 8 | [(C₄H₉)₄N⁺][C₄F₉SO₃⁻] (5) | — | Desmodur L 75 (0.1) |
| CE 1 | PSA 5 | [(C₄H₉)₄N⁺][C₄F₉SO₃⁻] (10) | — | Desmodur N 3300 |
| | | | | (0.2) |
| CE 2 | PSA 3 | Li⁺[⁻N(SO₂CF₃)₂] (15) | — | — |
| CE 3 | PSA 5 | Li⁺ClO₄⁻ (5) | — | Desmodur N 3300 |
| | | | | (0.2) |
| CE 4 | PSA 6 | — | — | Desmodur N 3300 |
| | | | | (0.2) |
| CE 5 | PSA 8 | Li⁺ClO₄⁻ (2.5), | — | Desmodur L 75 (0.1) |
| | | [(C₄H₉)₃(CH₃)N⁺][⁻N(SO₂CF₃)₂] (2.5) | | |
| CE 6 | PSA 5 | K⁺(C₄F₉SO₃⁻) (5) | Pycal 94 (5) | Desmodur N 3300 |
| | | | | (0.2) |

PPH = Parts per hundred parts of solids PSA
*Example 9 includes 0.05 PPH of 3-(glycidyloxypropyl)-trimethoxy silane

Table of Results

| | Initial Glass | Adhesion After 1 | Surface | DC Volume | Polarizer |
|---|---|---|---|---|---|
| | Adhesion | hour at 65° C. | Resistance | Resistivity | Durability |
| Ex. | (N/dm) | (N/dm) | (ohms/square) | (Ohms-cm) | Test |
| 1 | 13.8 | 15.0 | 3.6E+09 | — | Clear |
| 2 | 18.9 | 19.0 | 2.7E+09 | — | Clear |
| 3 | 11.5 | 12.8 | 9.2E+09 | — | OK |
| 4 | 8.6 | 9.1 | 7.8E+09 | — | Dimples |
| 5 | 7.4 | 8.0 | 6.3E+09 | — | Bubbles |
| 6 | 23.4 | 28.2 | 6.0E+10 | — | Ok |
| 7 | 14.0 | 20.7 | 4.6E+10 | — | Ok |
| 8 | 22.8 | 25.9 | 1.3E+10 | 1.64E+09 | OK |
| 9 | 18.5 | 22.7 | 7.2E+10 | 5.56E+09 | OK |
| 10 | 33.4 | 49.7 | 4.3E+09 | — | Bubbles |
| 11 | 25.2 | 50.8 | 6.0E+08 | — | Bubbles |
| 12 | 31.3 | 43.6 | 2.8E+09 | — | OK |
| 13 | 22.1 | 48.5 | 2.2E+09 | — | Clear |
| 14 | 23.1 | 35.9 | 9.8E+09 | — | OK |
| 15 | 13.8 | 25.0 | 5.6E+09 | — | OK |
| 16 | 11.7 | 33.6 | 4.8E+09 | — | Dimples |
| 17 | 10.1 | 18.9 | 4.1E+09 | — | Bubbles |
| 18 | 18.8 | 23.3 | 3.24E+11 | 4.48E+09 | Hazy |
| CE 1 | No Adhesion | No Adhesion | 7.8E+11 | — | Hazy |
| CE 2 | 45.6 | 72.9 | 1.8E+10 | — | Bubbles |
| CE 3 | 24.3 | 62.3 | 9.4E+11 | — | Clear |
| CE 4 | 15.1 | 19.5 | 5.0E+13 | — | OK |
| CE 5 | 17.5 | 47.5 | 1.09E+10 | 2.27E+09 | Delamination |
| CE 6 | — | — | 9.9E+10 | — | Hazy |

Comparative Example 1 exhibited no adhesion but could be improved through reducing the level of salt and/or adding plasticizer, as shown in the Examples above.

Various modifications and alterations will become apparent to those skilled in the art without departing from the scope and principles of this invention, and it should be understood that this invention is not to be unduly limited to the illustrative embodiments set forth hereinabove.

1. An optically clear display-grade adhesive comprising:
a crosslinked acrylic pressure sensitive adhesive;
an organic-soluble and dissociable salt; and
a non-hydrophilic plasticizer,
wherein the adhesive is electrostatically dissipative and is at least about 80% transmissive to visible light and is below about 10% haze.

2. The adhesive of claim 1 further comprising an adhesion promoting additive.

3. The adhesive of claim 2 wherein the adhesion promoting additive is selected from silanes and titanates.

4. The adhesive of claim 1 wherein the acrylic pressure sensitive adhesive comprises the reaction product of one or more acrylic or (meth)acrylic acid ester monomers and optionally a comonomer.

5. The adhesive of claim 1 wherein the acrylic pressure sensitive adhesive comprises the reaction product of one or more monomers selected from butyl(meth)acrylate, 2-ethylhexyl(meth)acrylate, ethyl(meth)acrylate, methyl(meth)acrylate, n-propyl(meth)acrylate, isopropyl(meth)acrylate, t-butyl(meth)acrylate, pentyl(meth)acrylate, n-octyl(meth)acrylate, isooctyl(meth)acrylate, isononyl(meth)acrylate and 2-ethylbutyl(meth)acrylate.

6. The adhesive of claim 1 wherein the salt comprises an alkali metal cation and an organic anion.

7. The adhesive of claim 1 wherein the salt comprises an organic cation and an organic anion.

8. The adhesive of claim 1 wherein the salt is provided in an amount effective to provide a surface resistivity level in the adhesive of below about 10¹¹ ohms per square, and/or in an amount effective to provide a bulk resistivity level in the adhesive of below about 10¹¹ ohm-cm.

9. The adhesive of claim 1 wherein the salt is provided in an amount from about 0.5 to about 5 weight percent, based on the weight of the acrylic pressure sensitive adhesive.

10. The adhesive of claim 1 wherein the salt and plasticizer are provided in an amount effective to provide both a surface and bulk resistivity level of the adhesive below 10¹¹ ohms per square and 10¹¹ ohm-cm respectively.

11. The adhesive of claim 1 wherein the salt comprises an anion of a strong Bronsted acid, or an anion selected from sulfonate, sulfonamide and sulfonimide.

12. The adhesive of claim 1 wherein the salt comprises an anion component selected from methide and borate.

13. The adhesive of claim 1 wherein the salt comprises a cation selected from an onium cation from periodic table Group IVb to VIIb, Group Vb to VIb, ammonium, phosphonium, sulfonium, lithium, sodium, and potassium.

14. The adhesive of claim 1 wherein the salt comprises a non-hydrophilic compound.

15. The adhesive of claim 1 wherein the salt comprises anions and cations that are not surface active.

16. The adhesive of claim 1 wherein the adhesive adhered to a polarizer film is removable from a glass surface after contact with the surface for at least about 7 days at a temperature of at least about 22° C. and a relative humidity of about 50%.

17. The adhesive of claim 1, wherein the salt comprises an inorganic ion and the plasticizer consists essentially of one or more non-hydrophilic plasticizers.

18. The adhesive of claim 1 wherein the plasticizer is provided in an effective amount, optionally from 0.01 to about 10 parts by weight (pbw) plasticizer based upon 100 pbw acrylic adhesive.

19. The adhesive of claim 1, wherein the plasticizer is selected from acrylic soluble plasticizers, including phosphate esters, adipate esters, citrate esters, phthalate esters, and combinations thereof.

20. The adhesive of claim 1, wherein the salt is selected from tetraalkylammonium bis-(perfluoroalkanesulfonyl)imides and tetraalkylammonium perfluoroalkanesulfonates.

21. The adhesive of claim 1 wherein the adhesive is substantially inert to a polarizing film.

22. An optically clear display-grade adhesive consisting essentially of:
a crosslinked acrylic pressure sensitive adhesive; and
an organic-soluble and dissociable salt,
wherein the salt comprises an alkali metal cation and an organic anion.

23. (canceled)

24. A multilayer polarizer comprising the adhesive of claim 1, optionally wherein the adhesive is provided on both sides of a polarizing film.

25. A multilayer polarizer comprising the adhesive of claim 1, wherein the polarizer further comprises one or more layers selected from an anti-glare layer, a protective layer, a reflective layer, a phase retardation layer, a wide-angle compensation layer, and a brightness enhancing layer.

26. A liquid crystal display comprising the adhesive of claim 1, a polarizer; and a liquid crystal cell, optionally wherein the adhesive is provided on both sides of the liquid crystal cell.

27. A method of making an optically clear display-grade adhesive comprising:
providing at least one acrylic monomer and optionally at least one comonomer, and optionally a photoinitiator;
blending the monomer(s) with an organic-soluble dissociable salt and a crosslinker to form an adhesive precursor composition;
providing the adhesive precursor composition onto a first release liner; and
activating the crosslinker to form a crosslinked acrylic pressure sensitive adhesive,
wherein the adhesive is electrostatically dissipative, and optionally wherein the adhesive is at least about 80% transmissive to visible light and is below about 10% haze.

28. The method of claim 27 further comprising providing a non-hydrophilic plasticizer and blending the plasticizer with the monomer(s), salt, and/or adhesive precursor composition.

29. The method of claim 27 further comprising laminating a second release liner onto a surface of the adhesive opposite the first release liner, optionally wherein the first and/or second release liner is electrostatically dissipative.
